(19) United States
(12) Patent Application Publication
(10) Pub. No.: US 2015/0158444 A1
(43) Pub. Date: Jun. 11, 2015

(54) Rear Bumper Guard

(71) Applicant: Yim Man Wu, Elmhurst, NY (US)

(72) Inventor: Yim Man Wu, Elmhurst, NY (US)

(21) Appl. No.: 14/628,066

(22) Filed: Feb. 20, 2015

Related U.S. Application Data
(63) Continuation-in-part of application No. 13/372,042, filed on Feb. 13, 2012, now abandoned.

(51) Int. Cl. B60R 19/44

(52) U.S. Cl. CPC B60R 19/44

(57) ABSTRACT

An external rear bumper guard for vehicles with trailer hitch receivers. The guard comprises an insertion bar and transverse bars, where the insertion bar is to be inserted and secured into the trailer hitch receiver of the vehicle, the bumper hitch and guard serving to protect the rear of the vehicle from damage. The bumper guard is easily removable.

### CROSS-REFERENCE TO RELATED APPLICATIONS

This application is a Continuation-in-Part of Non-provisional application Ser. No. 13/372,042 under 37 CFR 1.137(c) and claims the benefit thereof. This application also claims the benefit of U.S. Provisional Application No. 61/516,268, filed Apr. 1, 2011 and Design Application 29/374,147, filed Jul. 11, 201 and issued as USD673084 S1 on Dec. 25, 12012, the entirety of both of which are incorporated herein by reference.

### FIELD OF THE INVENTION

This invention elates generally to the field of guards used to protect bumpers on vehicles, and, more particularly, to guards to protect rear bumpers on autos, trucks, SUV's, and similar vehicles.

### BACKGROUND OF THE INVENTION

Vehicle bumpers are easily damaged even in low speed and parking lot collisions. Owners of vehicles benefit from ways to prevent this damage. Despite many attempts to solve the problem, all solutions fail to adequately provide a total solution. The present invention is believed to solve these problems.

Existing solutions to the problem divide into a number of major groups. One group consists of those bumper and rear end guards which must be bolted or otherwise connected with fastening hardware to the bodywork, usually to the frame, of the vehicle. Some are attached to the vehicle with nothing more than glue or Velcro strips. Some are designed as steps rather than as bumper guards. While steps may be useful, steps do not necessarily provide protection to the bumpers. Another group consists of guards which connect to the vehicle through a trailer hitch receiver. This receiver must already have been installed on the vehicle. Such receivers are quite common today. Many solutions are combinations of the preceding.

Each of these groups has problems. Clearly, any bumpers or guards which must be bolted or otherwise connected to the vehicle with fastening hardware usually require significant time to install. They tend to be heavy and costly. If they are damaged in a collision, removing and replacing them by oneself can be difficult. Hiring someone to do the job is costly.

Those guards which are glued to the vehicle or held in place by Velcro strips are for little more than decoration. Their flimsy plastic gives almost no protection in the event of a collision.

The guards that are designed as steps have to be made of substantial material. In some cases, they can be heavy, taking multiple people or equipment to install. Many of these guards must be bolted or otherwise connected with bolts or other fasteners to the vehicle,

Knowledge of basic physics should tell us that no guard can provide total protection in the event of a collision. No matter how strong a guard is, there is always a force great enough to overcome the protection afforded by the guard.

A guard that is heavy enough and strong enough to withstand a collision with a far larger vehicle, such as a semi-truck, can be very dangerous to the occupants of the vehicle. In a collision, energy from the other vehicle is transferred to the struck vehicle and, perhaps, to the occupants therein. The forces in a collision can be great. If the bumper guard is heavy, non-deformable, and bolted, welded, brazed, or otherwise fastened solidly to the frame or body of the vehicle, that energy must go somewhere.

Modern automotive design mandates use of deformable structures. The body of the vehicle is designed to crush in a controlled manner, absorbing energy. If that energy is not absorbed by deformation, the energy can be absorbed by the occupants.

It is desirable that a bumper guard be deformed in a collision where there is a lot of energy to be absorbed. However, after deformation, a bumper guard loses much of its usefulness. Then, the old, damaged bumper guard must be disposed of and a new bumper guard must be installed. Replacement should be so simple and the bumper guard so light that the vehicle owner can do the job.

Thus, what is needed to solve the foregoing problems is a bumper guard easily installed, easily replaced, light enough for anyone to lift, and which will protect in low speed collisions but deform in medium or high speed ones. In essence, the desired bumper guard is a sacrificial element in collisions. In sacrificing the bumper guard, risk of damage to the vehicle and its occupants is reduced substantially.

There are additional problems with the current crop of bumper guards which fit into the trailer hitch receiver. Different vehicles have different bumper heights. Some states mandate from a minimum of 14 inches to a maximum of 31 inches, Some owners convert their vehicles for off-road or other use. This means that the bumpers can be less than 14 or more than 31 inches from the ground. For example, pickup trucks modified for off-road use but still street legal can exceed that 31 inch height. Because vehicles often travel from their home state, it is well within the realm of possibility that a car will encounter another vehicle with a bumper height that is as much as 2 feet different from that of another vehicle. See http://drivinglaws.aaa.com/laws/bumper-height/ for 2015.

Most bumper guards consist of single bars, single tubes, or plates about 4 inches high. The range of protection is only as great as the height of the bar or plate or the diameter of the tube. One design extends the protection area downward by adding a small loop of tubing descending from the main tube. This descending loop covers only a fraction of the width of the main tube. This descending loop provides no protection against impact from the bumper of a vehicle the bumper height of which is above the height of the main tube,

What is needed to solve these problems is a bumper guard made with multiple bars or multiple tubes so that the bumper guard can protect against damage from vehicles whose bumpers can be at a range of heights. Despite there being a long-felt need for such protection, no other current bumper guard provides such protection.

Present art includes one example with two bars. U.S. Pat. No. 7,198,309 to Reynolds. This is not a bumper guard. It is a replacement for the entire bumper assembly. Thus, it is costly to replace if it is damaged, Unlike the present presumably heavy, components must be removed and replaced. Thus, it is not easily replaced. The bars are vertically aligned with one another, a limitation which would preclude bumper guards for bumpers which are not precisely vertical. In addition, this assembly, because it is a replacement bumper instead of a protector, protects only from impacts at the same height as the bumper assembly. The Reynolds bumper bars are internal to the bumper assembly. In the present invention, the bars are external to the vehicle. The bars in the present invention are not part of a bumper assembly. For this and other reasons stated, the Reynolds bumper is very different from the present invention, a bumper guard. There is no reason the present invention cannot be used to protect the Reynolds bumper from minor damage.

In an alternate embodiment, where the bars are long, the bumper guard can be stabilized by bolting or otherwise fastening the bars to the body or frame of the vehicle in addition to fastening the insertion tube to the receiver. These longer bars have additional brackets through which the fasteners are inserted.

After much analysis and experimentation, the present invention was developed. It is simple to install and replace, is relatively light in weight, and protects against damage from a range of vehicles.

### BRIEF DESCRIPTION OF THE DRAWINGS

The figures show the present invention in more detail.

FIG. 1 is a view of the bumper guard as if it were seen from directly behind the vehicle (vehicle not illustrated).

FIG. 2 is a view of the bumper guard as seen from above.

FIG. 3 is a view of the bumper guard as seen from below.

FIG. 4 is a view of the bumper guard as seen from the passenger side from the rear of a left-hand drive vehicle.

FIG. 5 is a perspective view of the bumper guard as seen from above and to the passenger side of the vehicle.

While the invention is amenable to various modifications and alternative forms, specifics thereof have been shown by way of example in the drawings and will be described in detail. It should be understood, however, that the intention is not necessarily to limit the invention to the particular embodiments, aspects, and features described. On the contrary, the intention is to cover all modifications, equivalents, and alternatives falling within the spirit and scope of the invention and as defined by the appended claims.

### DETAILED DESCRIPTION OF THE INVENTION

With reference to the drawings, the invention will now be described in detail with regard for the best mode and preferred embodiment.

In this description, the term “vehicle” will refer to any vehicle on which the bumper guard can be installed unless it is dear from the context that the term refers to a different type of vehicle. The term will include, but not be limited to, automobiles, trucks, SUVs, and trailers equipped with a hitch receiver.

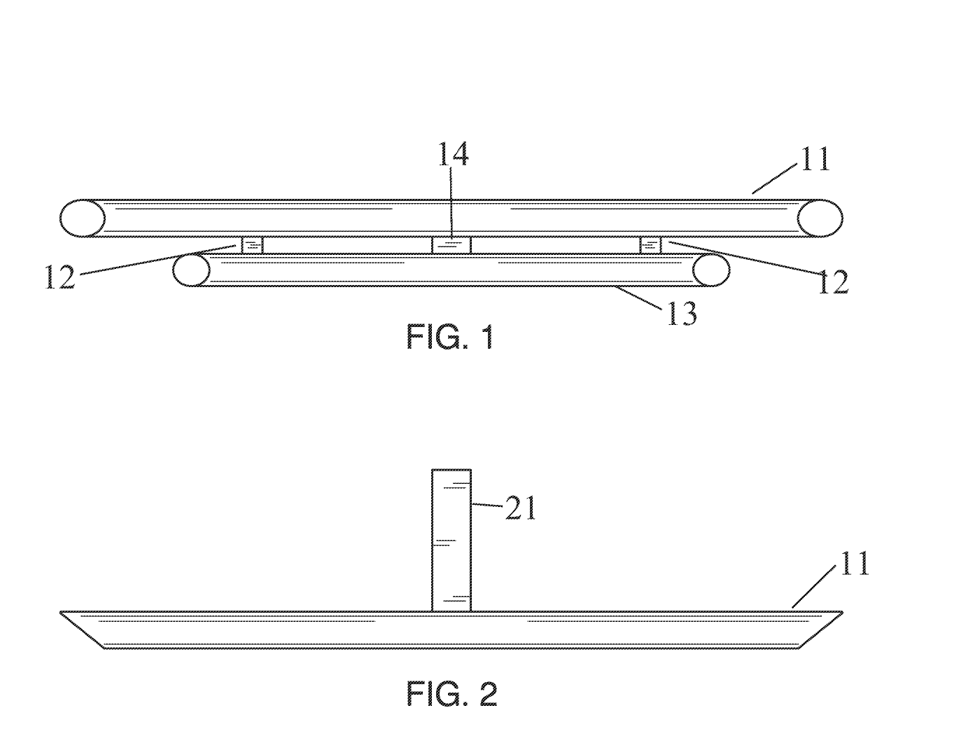

FIG. 1 shows upper transverse bar 11 and lower transverse bar 13 from what would be the rear of the vehicle when the bumper guard is installed on the vehicle. These transverse bars 11 and 13 are constructed of metal from solid or hollow tubes. In the preferred embodiment, the metal is ferrous but in alternate embodiments, the metal is non-ferrous. In the preferred embodiment, upper transverse bar 11 is 37 inches long and lower transverse bar 13 is 26 inches long, Upper and lower transverse bars 11 and 13 are joined to one another by two or more connectors 12 by methods well-known in the art. In the preferred embodiment, the two or more bars do not connect at the ends. In alternate embodiments, the bars are about the same length and connect at the ends, forming a bop or rectangular shape.

Connectors 12 are components welded or otherwise attached to upper transverse bar 11 and lower transverse bar 13. Connectors 12 are, in alternate embodiments, attached by bolts or screws to upper transverse bar 11 and lower transverse bar 13. In another embodiment, upper transverse bar 11, connectors 12, and lower transverse bar 13 are formed from a single casting.

The lengths of connectors 12 will determine the distance separating upper transverse bar 11 from lower transverse bar 13. In one embodiment, connectors 12 are one-half inch long. In alternate embodiments, connectors 12 could be about one foot long or more. Both connectors 12 need not be the same length. The longer connectors 12 are, the greater the range of bumper heights that the bumper guards will protect from damage,

Where connectors 12 are the same length, upper transverse bar 11 and lower transverse bar 13 he parallel to one other. In the preferred embodiment, upper transverse bar 11 is longer than lower transverse bar 13. In another embodiment, upper transverse bar 11 is the same length as lower transverse bar 13. In another embodiment, lower transverse bar 13 is longer than upper transverse bar 11. The relative positions of the upper transverse bar 11 and lower transverse bar 13 can be inverted by the user simply rotating the insertion tube 180 degrees about its long axis before inserting the insertion tube into the receiver.

FIG. 1 also shows one end 14 of insertion tube 21 (See also FIG. 2). insertion tube end 14 is connected to upper transverse bar 11 and lower transverse bar 13 by means well-known in the art, including welding or bolting. In one embodiment, upper transverse bar 11, connectors 12, lower transverse bar 13, and insertion tube 21, including end 14, are formed by a single casting.

FIG. 2 shows a top view of upper transverse bar 11 as well as the upper side of insertion tube 21. In the preferred embodiment, upper transverse bar 11 is longer than lower transverse bar 13. Thus, lower transverse bar 13 is not visible in this top view.

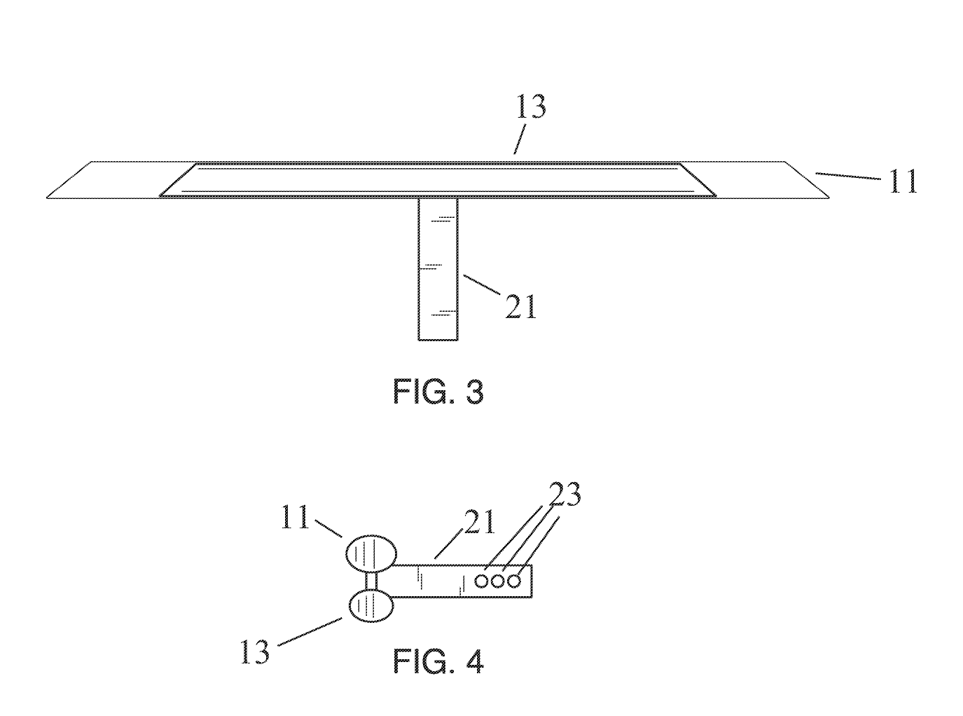

FIG. 3 shows a bottom view of lower transverse bar 13. In a bottom view of the preferred embodiment where upper transverse bar 11 is longer than lower transverse bar 13, the ends of the upper transverse bar 11 are visible beyond the ends of the lower transverse bar 13. Where upper transverse bar 11 and lower transverse bar 13 are the same length, upper transverse bar 11 would not be visible in this view.

FIG. 4 shows a side view of the bumper guard. Trailer hitch receivers are well-known in the art. In the vast majority of examples, trailer hitch receivers contain hollow square tubes into which insertion tubes are inserted for attachment by means well-known in the art. Trailer hitch receivers are widely available in two main sizes where one size is one-and-one-quarter inch per side and the other size is two inches per side. To fit into these trailer hitch receivers, insertion tubes, such as 21, are similarly available in sizes with sides that are one-and-one-quarter inches on the vertical and horizontal sides and two inches on the vertical and horizontal sides. In practice, these measurements are not exact. The hollow tube of the trailer hitch receiver is made slightly larger and the exterior dimensions of the sides of the insertion tube slightly smaller in order for the insertion tube to slide easily into the trailer hitch receiver.

Because the insertion tube 21 is square, in some embodiments it can be inserted into a trailer hitch receiver in any of four orientations depending on other factors. In the preferred embodiment, in which the upper transverse bar 11 is longer that the lower transverse bar 13, the insertion tube 21 is oriented with the upper transverse bar 11 above.

Insertion tube 21 contains one or more pin apertures 23. Said pin apertures are, in the preferred embodiment, one-half inch in diameter and match pin apertures on the opposite side of insertion tube 21. One or more pin apertures 23 are located on insertion tube 21 to match pin apertures in trailer hitch receivers. Said pin apertures 23 are adapted to receive a holding pin (not shown) which inserts through said pin apertures in the trailer hitch receiver to secure the bumper guard to the trailer hitch receiver. Precise locations of said pin apertures on both trailer hitch receivers and insertion tubes 21 are standardized within the art and are not claimed in this invention.

The length of insertion tube 23 is, in the preferred embodiment, eight inches. However, other lengths are well-known within the art. Longer or shorter lengths determine how far beyond the trailer hitch receiver the bumper guard will be positioned. If, for example, the vehicle has a rear liftgate, it may require a longer insertion tube 21 so that the bumper guard will not interfere with operation of the liftgate when the liftgate is being raised,

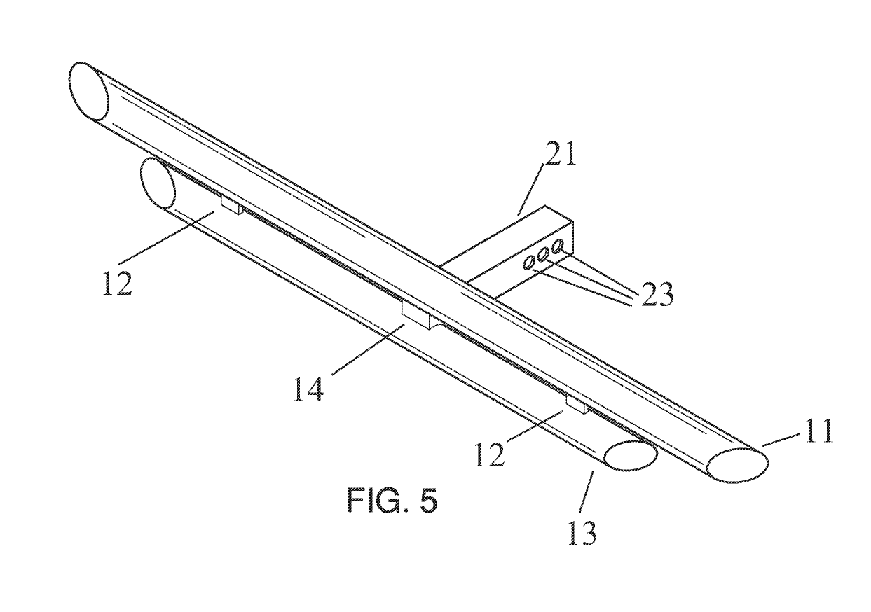

FIG. 5, the perspective view of the bumper guard, shows all parts of the invention in the preferred embodiment.

The above descriptions disclose a bumper guard with two transverse bars. In alternate embodiments the bumper guard comprises two or more transverse bars connected to the insertion tube. These bars may be parallel to one another or may be disposed in a range of angles. The bars may be straight or curved. The bars may be circles or loops depending on the desired application.

It is understood that equivalents and substitutions for certain elements set forth above may be obvious to those skilled in the art and, therefore, the true definition and scope of the invention are to be as set forth in the claims herewith.

I claim:

1. An external bumper guard for protecting from damage the bumper of a vehicle with an existing trailer hitch receiver, said external bumper guard comprising an insertion tube and two or more bars connected to the insertion tube and to one another.

2. The external bumper guard of claim 1 in which the two or more bars are parallel to the plane of the ground on which the vehicle stands and are parallel to one another.

3. The external bumper guard of claim 1 in which the insertion tube is of size a little less than the size of the receiver and is of the same shape such that the insertion tube can be inserted into the existing trailer hitch receiver and held therein by a pin which pin passes through apertures in the receiver and insertion tube.

4. The external bumper guard of claim 1 wherein the insertion tube and bars are made of ferrous or non-ferrous metal.

5. The external pumper guard of claim 1 in which the two or more bars are from one-half inch to twelve inches apart from one another.

6. The external bumper guard of claim 1 in which the two or more bars are of different lengths.

7. The external bumper guard of claim 1 in which the longest bar is about 37 inches long.

8. The external bumper guard of claim 1 in which the shortest bar is about 26 inches long.

9. The external bumper guard of claim 1 in which the two or more bars are of about the same length.

10. The external bumper guard of claim 9 in which the ends of the two or more bars are connected at the ends to form loops or rectangles.

11. The external bumper guard of claim 1 wherein the bars are connected to the insertion tube and to one another by welding, brazing, or use of fasteners.

12. The external bumper guard of claim 1 wherein the bars and the insertion tube are formed from a single casting.
